(19) United States
(12) Patent Application Publication
(10) Pub. No.: US 2014/0259902 A1
(43) Pub. Date: Sep. 18, 2014

(54) LANDSCAPE EDGING SYSTEM

(71) Applicant: KEYSTONE RETAINING WALL SYSTEMS LLC, Minneapolis, MN (US)

(72) Inventors: Joseph M. Friederichs, Lakeville, MN (US); Thomas S. Riccobene, Albuquerque, NM (US)

(73) Assignee: KEYSTONE RETAINING WALL SYSTEMS LLC, Minneapolis, MN (US)

(21) Appl. No.: 13/835,963

(22) Filed: Mar. 15, 2013

(51) Int. Cl. A01G 1/08

(52) U.S. Cl. CPC A01G 1/08
USPC 47/33; 47/58.1 R

(57) ABSTRACT

An improved landscape edging system is described. The landscape edging system includes an edge piece having a first end and a second end, the edge piece having a substantially vertical wall and a base, the base comprising a first footing at the first end and a second footing at the second end, the first footing being spaced apart from the second footing, the first and second footings having a stake opening, the first end having an inwardly stepped section on the wall and a stepped up section on the base. A method of installing the landscape edging system is also described.

### FIELD OF THE INVENTION

The present invention relates to landscape edging systems for retaining in place pavers, bricks and landscape stones employed in outdoor patios, walkways, flowerbed borders and other landscape settings.

### BACKGROUND

Outdoor patios, driveways and walkways are frequently formed by placing landscape stones on a bed of sand or gravel. Typically, no cementitious or other binding material is employed to lock the stones in place. Consequently, there is a tendency for the stones to migrate laterally, to shift and sink, and to fall into disarray, leaving an unsightly and potentially dangerous walking surface rather than the smooth and attractive surface originally intended. Similarly, stones are employed for flowerbed and lawn borders and edgings and the like have a tendency to shift and fall into disarray.

Many systems have been proposed for retaining the marginal edge elements of such patios, walkways and edgings in place, thereby to constrain all of the stones in the patio or walkway against movement. In some cases, cementitious material is used to retain the borders. In other cases, devices are used to retain the borders. These devices have ranged from simple stakes or spikes driven into the ground contiguous to the marginal stones to plural element edging systems comprised of complex edging strips and securing spikes.

Prior art landscape retaining systems thus have met with varying degrees of success and failure. As always, there is considerable room for improvement.

### SUMMARY OF THE INVENTION

One aspect of the invention involves an improved landscape edging system. In one embodiment, the landscape edging system includes a flexible edge piece having a first end and a second end, the edge piece having a substantially vertical wall and a base, the base comprising a first footing at the first end and a second footing at the second end, the first footing being spaced apart from the second footing, the first and second footings having a stake opening, the first end having an inwardly stepped section on the wall and a stepped up section on the base.

Another aspect of the invention involves a method of installing a landscape edging system. In one embodiment, the method includes providing at least two edge pieces having a first end and a second end, the edge pieces having a substantially vertical wall and a base, the base comprising a first footing at the first end and a second footing at the second end, the first footing being spaced apart from the second footing, the first and second footings having a stake opening, the first end having an inwardly stepped section on the wall and a stepped up section on the base. The inwardly stepped section and the stepped up section of the first end of the first edge piece are positioned over the second end of the second edge piece forming an overlapping portion, the stake openings in the first and second edge pieces being aligned. A stake is inserted into the stake openings in the first and second edge pieces to secure the first and second edge pieces together and to the ground forming a smooth continuous edge.

### BRIEF DESCRIPTION OF THE DRAWINGS

FIG. 1 is a perspective view of one embodiment of an edge piece.

FIG. 2 is a perspective view of another embodiment of the edge piece.

FIG. 3 is a perspective view of one embodiment of a connection between two edge pieces using a stake.

FIG. 4 is a perspective view of a stake.

FIG. 5 is a side view of the landscape retaining stake illustrated in FIG. 4.

FIGS. 6-9 are elevational views illustrating in sequence the steps involved in installing the landscape edging piece of FIG. 1.

FIG. 10 is a cross-section of one embodiment of an installed landscape edging system.

FIG. 11 is a cross-section of another embodiment of an installed landscape edging system.

### DETAILED DESCRIPTION OF THE INVENTION

The landscape edging system is designed to maintain the edge of stone patios, driveways, and walkways. Herein the term “stone” means natural stone and manufactured landscape stones, pavers, bricks and the like.

The landscape edging system includes one or more flexible edge pieces which are secured in the ground using stakes. The edge pieces can be easily connected and shaped to fit the design of the patio, etc. The edge pieces have a substantially vertical wall and a base. There are horizontally extending footings at each end. The footings have stake openings so that the edge pieces can be connected with stakes. One of the ends has an inwardly stepped section on the wall and a stepped up section on the base. The stepped sections overlap the end of the next edge piece and are connected with a stake extending through both pieces. This creates a smooth connection between two edge pieces, allowing two or more edge pieces to function as a single piece to create convex, concave, and/or serpentine alignments.

The landscape edging system includes an edge piece 100 as illustrated in FIG. 1. The edge piece 100 is an elongated L-shaped piece which has a substantially vertical wall 105 and a base 110. The wall 105 of the edge piece 100 extends from a first end 112 to a second end 122. The base 110 has a first footing 115 at the first end 112 and a second footing 125 on the second end 122.

The first footing 115 has a stake opening 120, and the second footing 125 has a stake opening 130. The stake openings 120, 130 can have any suitable shape. Suitable shapes include, but are not limited to, rectangular, square, round, or oval.

The wall 105 of the second end 122 has an inwardly stepped section 155, and the base 110 of the second end 122 has a stepped up section 160.

In some embodiments, there can be one or more intermediate footings 135 between the first and second footings 115, 125. The first, second and/or intermediate footings 115, 125, 135 are spaced apart and joined by narrow base members 140 between footings. The presence and number of intermediate footings 135 will depend on the length of the edge piece 100. The narrow base members 140 between footings allow the edge piece 100 to flex in a transverse direction (substantially orthogonal to the wall) so that the edge piece 100 can be positioned in convex, concave and serpentine curves. Base members 140 provide structural integrity to the edge piece 100 and walls 105. In some embodiments, however, the narrow base members 140 can be omitted.

In some embodiments, one or more braces 145 are provided between wall 105 and the first, second, and/or intermediate footings 115, 125, 135 which provide rigidity to the edge piece 100. In one embodiment, braces 145 are provided on intermediate footings 135, but omitted from the first and second end footings 115, 125, as shown in FIG. 1. The braces 145 are preferably substantially perpendicular to and integral with the wall 105 and the footings. In one embodiment, the brace is triangular, although other shapes could be used, if desired. In another embodiment as shown in FIG. 2, stiffeners 147 are attached to the wall 105 extending between footings. The stiffener 147 can extend over at least a portion of the footings on both sides of the intermediate space.

In some embodiments, one or more of the intermediate footings 135 can have stake openings 150 so that the edge piece 100 can be secured in the ground at intermediate points between the first and second ends 112, 122. Further, the footings can be provided with multiple openings of different shapes to thereby provide multiple options for driving stakes in different places and in different directions to better secure the edging system.

The edge piece 100 may be made of any suitable material and any manufacturing process, such as injected molded plastic, extruded plastic, and punched plastic.

A connection between two edge pieces 100, 200 is illustrated in FIG. 3. The second end 122 of edge piece 100 overlaps the first end 212 of a second edge piece 200. The inwardly stepped section 155 and the stepped up section 160 of the second end 122 of the first edge piece 100 fit over the wall 205 and base 210 of the first end 212 of the second edge piece 200 so that the bottom and rear surfaces of the overlapped section are flat, while the front and top surfaces have a step. This provides a smooth surface on the wall facing the stones and the bottom of the edge piece overlying the ground surface.

A stake 10 is placed through stake opening 130 in the second end 122 of the first edge piece 100 and the stake opening in the second edge piece 200. The stake 10 secures the two edge pieces 100, 200 together and into the ground.

The stake can have any suitable shape for retaining the edge pieces in the ground. Suitable shapes include, but are not limited to, square, rectangular, triangular trapezoidal, circular, oval, H-shaped, or other geometric shape. The stake and the stake opening have the same shape, creating a continuous edge from two or more edge pieces.

In some embodiments, the stake can have the shape described in U.S. patent application Ser. No. 11/827,888, filed Jul. 13, 2007, entitled LANDSCAPE RETAINING STAKE, which is incorporated herein by reference.

As shown in FIGS. 4 and 5, the landscape retaining stake, indicated generally at 10, is comprised of an elongate body 12 having a tapered lower end 14 and an upper end or head 16. The cross-sectional shape of body 12 is shown as being essentially square, but could be other shapes as described above. The lower tapered end is preferably chisel-shaped. The stake may be made of any rigid, sturdy and long lasting material, such as metal, plastic and preservative treated wood.

The length and cross-section of the body 12 may be sized according to the demands of the particular application for which the stake is intended. For conventional garden, footpath and patio applications, a recommended cross-section is in the order of ¾ inch by ¾ inch and a recommended length is about 8 to 12 inches. The body has a front or forward face 20, a back or rear face 22, and parallel side faces 24. The back face 22 is inclined upwardly and rearwardly relative to the forward face 20.

The head 16 of the stake is comprised of a generally flat anvil or striking surface 30 and a forwardly projecting abutment 32 having an edge piece abutting surface 34 and an edge piece receiving notch 36. Force supplied by a hammer or sledge to the surface 30 of the head (as depicted in FIGS. 6-9) will be transmitted along a line of force (indicated by dot dash line 38) extending generally normal or perpendicular to the flat surface 30 of the anvil. The anvil is preferably so located that the line of force 38 is offset rearwardly from the center line of the body 12. The front face 20 of the stake body 12 is preferably generally parallel to the line 38 of applied force. The back or rear face 22, on the other hand, is inclined rearwardly from bottom to top at an angle from about 0.1 degrees to about 20.0 degrees relative to line parallel to the line of force, or about 0.1 degrees to about 15.0 degrees, or about 0.1 degrees to about 10.0 degrees, or about 0.1 degrees to about 5.0 degrees. A most preferably angle is about 2.4 degrees, which results in about a one-quarter inch wedge for an 8 inch stake.

The tapered lower end 14 of the body 12 is preferably chisel shaped with inclined front and rear faces 40 and 42 respectively, which join to form a knife edge 44 at the lower end or bottom of the stake to facilitate entry of the stake into the ground. The face 40 is inclined at an angle from about 8 to about 30 degrees relative to a line parallel to the line of force. Preferably, the back face is inclined at about the same, albeit reverse, angle such that the edge 44 is approximately laterally centered in the lower end of the stake. The lateral location of edge 44 will affect the degree of rotation of the stake as it is driven into the ground. The degree of rotation will be increased the greater the lateral distance between edge 44 and line of force 38. It is preferred that edge 44 is located laterally at or forwardly spaced from the line of force, and it is most preferred that edge 44 is at the lateral midpoint of the lower end 14 offset forwardly from the line of applied force 38, as shown in FIG. 5.

The abutment surface 34 is preferably set at an angle such that it will be flush with the wall 105 of edge piece 100 when fully installed (see FIG. 9). More specifically, surface 34 is preferably inclined at an angle of about 5 to about 10 degrees greater than lower end front face 40, relative to a line parallel to the line of force 38, for reasons that will become clear from the installation method described below. The abutment top surface 33 is preferably set an angle of approximately 90 degrees relative to the abutment surface 34. The top surface is of sufficient length, preferably about ¾ inch, to space the anvil surface away from the edge piece during installation.

In some embodiments as shown in FIGS. 4 and 5, a notch 50 is provided in face 40 which is configured to receive edge 52 of another stake to facilitate packaging multiple stakes. Two stakes can be nested with the head of one adjacent to the bottom of another. The edges 52 of each stake engage the notches 50 of the adjoining stake, preventing the stakes from sliding relative to one another. In one packaging embodiment, 6 stakes are wrapped together as 3 side-by-side pairs.

A method of installing the stake 10 to an edge piece 100 in a garden, patio or walkway is illustrated in FIGS. 6-9. As is conventional for a patio or walkway, a plurality of stones P are set contiguous to one another in a select pattern on a bed B of sand or gravel. Unless the stones at the border of the patio or are constrained against movement, the stones will migrate laterally and fall into disarray, leaving an unsightly and potentially dangerous walking surface rather than the smooth attractive surface intended. The landscape edging system of the invention prevents this from happening.

As illustrated in FIG. 6, an edge piece 100 is positioned against stones P with the wall 105 firmly set against stone P. A stake 10 is initially positioned generally upright, with its front or forward surface 20 generally facing the wall 105 of the edge piece 100. The knife edge 44 of the stake engages the ground contiguous to the lower edge of the wall 105 and the front face 40 of the lower end 14 of the stake is positioned substantially flush against the wall 105 such that the upper end of the stake is tilted rearwardly. The slope of the forward inclined face 40 of the stake is significant as this surface is employed as an alignment guide for properly setting the initial entry angle of the stake as the first step in the installation process. As plural stakes are driven into place, the installer may wish to modify the initial entry angle departing slightly from the flush relationship between face 40 and the wall 105. In any event, face 40 operates as an alignment guide.

With the stake thus aligned with the edge piece 100, several strokes or blows applied with a hammer, sledge or like implement H to the anvil or striking surface 30 of the stake commences driving the knife edge 44 of the stake into the ground while maintaining the front face 40 of the lower end of the stake in engagement with the wall 105 as depicted in FIGS. 6 and 7. As with any stake, spike or nail, it is important to squarely strike the head 30 when driving the stake.

When the face 40 of the stake clears (passes below) the base 110, the front face 20 of the stake engages the lower edge of the wall 105. Due to the wedging force that is produced by the inclined rear or back surface 22 of the stake, the stake body is urged laterally towards the wall 105 to maintain firm engagement of wall 105 with the stone P. Further, the combination of the wedging force and the rearward offset of the line of force applied by the hammer to the anvil causes the stake to pivot or turn using the lower edge of the wall 105 as a fulcrum, such that the lower end 14 of the stake moves in under the wall 105 of the edge piece 100. The amount of rotation that occurs depends on a variety of factors including the specific geometry of the stake, and the composition and moisture content of the bed. Rotation of about 5 to about 10 degrees has been observed in installations of the stake shown and described in this preferred embodiment in sand and/or gravel beds. Consequently, with continued hammering on the anvil 30, the body 12 burrows into the bed B underneath the edge piece as is illustrated in FIGS. 8 and 9.

With the final few blows of the hammer on the anvil, as illustrated in FIGS. 9 and 10, the abutment surface 34 on the head 16 is moved into engagement with the wall 105 to restrain lateral movement or displacement of the edge piece and stone P. In addition, front face 20 at notch 36 engages the lower edge of the wall 105. Most preferably, as shown in FIG. 10, the abutment surface 34 is flush with the wall 105, and the notch 36 is in mating engagement with the lower edge 106 of the wall. It is nevertheless acceptable if the stake has been driven to a final angle that slightly off the most preferred angle. If the angle is too shallow, the notch 36 will nevertheless engage the lower edge of the wall 105, retaining it laterally and vertically. On the other hand, if the angle is too steep, the top edge 52 of the abutment surface will engage the wall 105, thus providing retention, as shown in FIG. 11.

As appears in FIG. 9, the abutment 32 spaces the anvil 30 laterally away from the wall 105 so as to mitigate inadvertent hammer blows and consequent damage to the edge piece. When fully installed, the abutment top surface 33 is generally parallel to the ground and the anvil 30 forms a desirable chamfer with the ground.

After the edge pieces are anchored in the ground, backfill and optionally grass, sand or gravel is placed on the exposed side over base 110. The stones P are thus secured by the edge system 100.

While a preferred embodiment of the landscape retaining stake of the invention has been herein illustrated and described, it is to be appreciated the various changes, rearrangements and modifications may be made therein without departing from the scope of the invention as defined by the appended claims.

What is claimed is:

1. A landscape edging system comprising:
at least one edge piece having a first end and a second end, the edge piece having a substantially vertical wall and a base, the base comprising a first horizontally extending footing at the first end and a second horizontally extending footing at the second end, the first footing being spaced apart from the second footing and the edge piece being flexible in a transverse direction between the first and second footings, the first and second footings each having a stake opening, one of said ends having an inwardly stepped section on the wall and a stepped up section on the base.

2. The landscape edging system of claim 1 wherein said base further comprises a member connected to the wall between the first and second footings which is narrower than the first and second footings.

3. The landscape edging system of claim 1 further comprising at least one brace between the wall and base.

4. The landscape edging system of claim 1 further comprising at least one intermediate footing between the first footing and the second footing, the at least one intermediate footing being spaced apart from the first and second footings.

5. The landscape edging system of claim 4 further comprising at least one brace between the intermediate footing and the wall.

6. The landscape edging system of claim 4 wherein the base includes members connected to the wall and extending between the first, second, and the at least one intermediate footings which members are narrower than the first, second, and at least one intermediate footings.

7. The landscape edging system of claim 4 wherein the at least one intermediate footing has at least one stake opening.

8. The landscape edging system of claim 4 wherein at least some of said footings have plural stake openings.

9. The landscape edging system of claim 1 wherein there are at least two edge pieces.

10. The landscape edging system of claim 9 further comprising at least one stake.

11. The landscape edging system of claim 10 wherein the stake has a cross-section of a square, a rectangle, a triangle, a trapezoid, a circle, an oval, or an H-shape.

12. The landscape edging system of claim 10 wherein the stake comprises:
an elongate body having an upper end, a lower end, a front side, and a rear side;
an anvil surface on the upper end of said body generally perpendicular to said body, and defining a line of force extending longitudinally through said body and being normal to said anvil surface;
a front face on the front side of said body being generally parallel to said line of force; and
a rear face on the rear side of said body being inclined rearwardly from said line of force from the lower end to the upper end to form a wedge on the rear side of the stake body.

13. The landscape edging system of claim 12, wherein said upper end comprises an abutment on the front side of said body, said abutment having a top face inclined forwardly and downwardly from said anvil surface and an abutment surface inclined downwardly and rearwardly from the top face, the abutment surface being adapted to engage the substantially vertical wall of the edging piece to restrain lateral movement of the edging piece.

14. The landscape edging system of claim 13, wherein the abutment surface and the front face of the body meet to define a notch, and wherein the front face is adapted to engage a lower edge of the wall of the edge piece when the stake is being driven and the lower edge of the wall being received in the notch for retaining the edge piece against vertical sinking when the stake is driven fully into the ground.

15. The landscape edging system of claim 12 wherein said line of force is offset rearwardly from a center line of said body.

16. A landscape edging system comprising:
a plurality of edge pieces, each edge piece having a first end and a second end, the edge piece having a substantially vertical wall and a base, the base comprising a plurality of horizontally extending footings including a first footing at the first end, a second footing at the second end and at least one intermediate footing, the footings being spaced apart from one another and the edge piece being flexible in a transverse direction between the footings, the first, second and intermediate footings each having at least one stake opening, the one end of each edge piece has as stepped configuration including an inwardly stepped section on the wall and a stepped up section on the base;
wherein the stepped configuration of the one end of one of said edge pieces is configured to overlap the other end of another of said edge pieces and that the respective stake openings in the overlapping ends are configured to align; and
a plurality of stakes having a configuration to be received in the stake openings in the edge pieces.

17. A method of installing a landscape edging system comprising:
providing at least two edge pieces having a first end and a second end, the edge pieces having a substantially vertical wall and a base, the base comprising a first footing at the first end and a second footing at the second end, the first footing being spaced apart from the second footing, the first and second footings having a stake opening, the second end having an inwardly stepped section on the wall and a stepped up section on the base;
positioning the inwardly stepped section and the stepped up section of the second end of the first edge piece over the first end of the second edge piece forming an overlapping portion, the stake openings in the respective ends of the first and second edge pieces being aligned; and
driving a stake into the stake openings in the first and second edge pieces to secure the first and second edge pieces together and to the ground forming a smooth continuous edge.

18. The method of claim 17 further comprising bending the edge piece to define a curved edge.

19. The method of claim 17 wherein at least one of the edges pieces has at least one intermediate footing between the first and second footings, the intermediate footing having a stake opening, and further comprising inserting a stake into the stake opening in the at least one intermediate footing.

20. The method of claim 17 further comprising placing backfill over the base of the edge piece.
